(19) United States
(12) Patent Application Publication
(10) Pub. No.: US 2021/0407698 A1
(43) Pub. Date: Dec. 30, 2021

(54) ELECTROLYTIC TREATMENT FOR NUCLEAR DECONTAMINATION

(71) Applicants: C-TECH INNOVATION LIMITED, Chester (GB); NATIONAL NUCLEAR LABORATORY LIMITED, Warrington (GB)

(72) Inventors: Robert BELL, Chester (GB); John COLLINS, Chester (GB); Luke O'BRIEN, Warrington (GB)

(21) Appl. No.: 17/290,043

(22) PCT Filed: Oct. 29, 2019
(86) PCT No.: PCT/GB2019/053059

§ 371 Date: Apr. 29, 2021

(30) Foreign Application Priority Data
Oct. 29, 2018 (GB) 1817604.0

(51) Int. Cl. G21F 9/00

(52) U.S. Cl. CPC G21F 9/004

(57) ABSTRACT

An electrolytic treatment system to decontaminate the surface of a radioactively contaminated metallic workpiece has at least two electrodes in close proximity to the surface but not in direct electrical contact. The electrodes are separated from the surface by an electrolyte. Insulation is provided in the electrolyte between the electrodes to avoid or minimize a direct current path between the electrodes though the electrolyte.

### BACKGROUND OF THE INVENTION

### 1. Field of the Invention

This invention relates to the treatment of nuclear contamination especially its removal from surfaces.

In this specification any reference to “surface” or “items” is used to refer to the surface of metallic articles and items contaminated with radionuclides such as but not limited to pipes, vessels, tubes, ducts, boxes, tanks, flasks, cylinders, shafts, gears, wheels, structures and herein referred to as item(s), object(s) or workpiece(s).

### 2. Background of the Invention

Decontamination of metal surfaces is a common problem in industry, including in the nuclear industry where metal comes into contact with radionuclides and becomes contaminated. Contaminated metal may include ducting, pipework, glove boxes, storage vessels, mechanical parts such as stirrers etc. Once the metal has been in contact with media containing radioactive species then there remains behind on the surface some residual radioactivity which cannot be removed by simple rinsing or washing, since the radioactive elements have either reacted with the surface or else penetrated a short way into it. There may be some diffusion into the surface, either directly into the surface of the metal and or along cracks propagating into the metal. The result is that there is radioactivity associated with the surface.

It is therefore desirable to remove radioactive contamination from the surfaces of items. If the classification of such materials can be lowered, then there is a considerable practical advantage in the decommissioning of nuclear plant since a greater part of the contaminated material can be handled with less risk to operators and with less requirement for high-level radioactive waste storage.

Handling of contaminated material is often a challenge as operators cannot get close to it or are unable to be near it for long periods, since proximity contributes to the allowable radiation exposure to operators. Additional precautions and methods and facilities are required therefore to deal with this contamination, with the objectives of removing the contamination, minimizing hazard to health, and recovering decontaminated metal for re-use via conventional recycling processes.

An additional challenge is that surface contamination is not static—it can change in response to a surface treatment. It is found in some instances that after removal of a contaminated surface layer that the contamination “sweats back”—that is to say that the radioactivity at the surface is reduced after the decontamination treatment but then subsequently increases. This is as a result of diffusion of species from the sub-surface layer to the newly created surface. This underlines the need for having effective control over any decontamination process.

A conventional means to deal with this problem is the physical removal and disposal of the whole item. The obvious drawback to this method is that the quantity of contaminated material to be disposed of or stored is larger, and there is no possibility to return any of the material to general use via recycling.

A second means is to use a smelter as described in U.S. Pat. No. 5,268,128 (WESTINGHOUSE) 7 Dec. 1993 “Method and apparatus for cleaning contaminated particulate material”, with operating conditions such that the radioactive contamination ends up in the slag, which can be isolated and then stored indefinitely, combined with treatment of the radioactive metal waste using melt decontamination as described in US 2013296629 A (KEPCO NUCLEAR FUEL CO LIMITED) 7 Nov. 2013 and recovering the bulk of the metal as an uncontaminated stream for reuse. This process is operated commercially. The disadvantage of this approach is that a large facility is required, which itself requires extensive control measures.

It is preferable therefore to have a means of decontaminating the material such that the larger part of the metallic base can be recycled without further precaution. This may be applied in-situ, to vessels for example, so that dismantling and decommissioning operations can be carried out with reduced hazard, and it may be applied after dismantling and with the objective of recovering more material for re-use.

The first step in any such process is the removal of any contaminants such as grease or paint. Suitable processes may include the use of solvents to remove greases and the use of abrasive techniques such as grit blasting to remove paint. Laser ablation as described in US 2009060780 A (WESTINGHOUSE ELECTRIC GERMANY) 5 Mar. 2009 “Device & method for the treatment and or decontamination of surfaces” or machining of surfaces may also be used. These methods are effective but are slow and manually intensive processes that generate particulate waste and vapors and therefore present additional hazard control and containment challenges. Solvent based processes have the additional disadvantage that organic material may be introduced that subsequently contaminates the downstream processing and extraction of radionuclides.

Having removed grease and paint a means of removing the surface layer of metal is required. There are various means known.

One method is to chemically dissolve the contaminated layer of metal, including any oxide or other deposited layer. The challenge is to dissolve this contaminated layer completely whilst at the same time dissolving only a finite and controlled amount of the uncontaminated substrate metal. Acid treatments are used for mild steel and stainless steel including 304 stainless steel and also for other materials. Nitric acid is commonly used in the nuclear industry because of the high solubility of the contaminants of interest as nitrates, and because of the good corrosion resistance of 304 stainless steel to nitric acid. The radioactive contamination is recovered from the nitric acid by standard means including precipitation and flocculation, for example as used in the Enhanced Actinide Removal Plant (EARP) at Sellafield, UK.

Other chemical treatments of metal surfaces are known in the metals finishing industries where thermal processing of metals gives rise to an oxide surface layer which must be removed before further processing steps can be carried out. Various chemical treatments are known including the use of acetic acid (hence the use of the term “pickling”), sulphuric acid and other or additional agents such as hydrochloric acid for mild steel and hydrofluoric acid for stainless steel, or hydrofluoric/nitric acid mixtures. These treatments are not preferred for use in nuclear decontamination because they are incompatible with the stainless-steel construction of the downstream effluent treatment plants.

A limitation with the use of nitric acid as a dissolution agent is that the dissolution reaction is slow so that relatively larger plants are required to deal with the large volumes of acid reagents required. The rate of reaction can be increased through the addition of complexing agents such as chloride, fluoride, and organic complexing agents such as citric acid, oxalic acid and ethylene diamine tetra acetic acid. These agents increase the rate of reaction with the surface contamination but at the expense of creating a liquid which is more corrosive, and which cannot be treated using conventional nuclear effluent treatment plant, being corrosive to the metals used in their construction.

A different method of surface decontamination is described in U.S. Pat. No. 7,384,529 B (US ENERGY) 10 Jun. 2008 “Method for electrochemical decontamination of radioactive metal”, where a current is passed through the contaminated article using a conductive electrolyte bath. Electrochemical descaling (or “electro-pickling”) is commonly used in metals processing. This method has the significant advantage over chemical methods in that the rate of surface removal is very much greater than with chemical methods. The practical consequence is that an electrochemical treatment requires a much smaller quantity of acid reagent that a chemical treatment. An additional advantage is that electrochemical processes are easily controllable since an electrochemical process responds immediately to the level of current passing which in turn is determined by the electrical potential applied. Electrochemical processes have the significant drawback however in that they are only effective where the geometry allows the placement of the counter-electrode close to the working piece. This is because the electric field decreases quickly away from the gap between the working piece (working electrode) and counter electrode. In the present invention this limitation is referred to as a limited “throwing power” compared to chemical etching methods which act wherever fresh solution comes into contact with metal. “Throwing power” is a term used in the electroplating industry. A good throwing power in an electro-plating process refers to relatively higher rates of electro-plating in areas where the electric field is weak, in comparison with poor throwing power where the rate of deposition is relatively slower in the same areas of weak electric field. In describing this invention “throwing power” is used in the following sense for electro-chemical removal of surface layers: a good throwing power means that the rate of surface removal is relatively high in areas of weak electric field compared to a process with poorer throwing power where the rate of removal in an area of weak electric field is relatively lower.

The choice of electrical waveform for use in electro-pickling has been the subject of previous study and it has been found advantageous to combine a direct current offset to an alternating current waveform. It has been shown in US 2003075456 A (COLLINS ET AL) 24 Apr. 2003 that it is possible to descale a wide range of metals coated with oxide films more rapidly using AC waveforms with DC bias, than when using AC waveforms without DC bias. It was also shown that it can be advantageous to periodically reverse the polarity of the DC bias. Removal or cleaning of the oxide layers on the surface of metals was shown to be faster when a DC bias was applied to an AC waveform, compared to the use of AC current alone. The cleaning mechanism involves some dissolution of the contaminated layer, some undercutting where the underlying metal is dissolved, and some scrubbing action resulting from the generation of gas bubbles at the interface.

AC with DC bias allows breakdown of oxide film faster—because in the potential range where dissolution occurs DC current alone leads to either passivation of the surface or oxygen evolution and pitting, whereas AC current alone gives a reduced dissolution effect. AC current with DC bias is found to give the optimum dissolution whilst minimising localised pitting.

The use of electrodes and applying a DC voltage for treating the internal surface of a pipe has been shown previously in U.S. Pat. No. 6,217,726 B (THERMA CORP) 17 Apr. 2001 presenting a method where a connection is made directly to the pipe to form one electrode and the second electrode is formed comprising a series of connected spherical electrodes as a means of electrochemically etching the inner surface of a pipe. In this case the single potential electrodes moved through the pipe, with the pipe connected to the power supply and acting as the 2nd electrode to make the circuit. For many processes alternation of the electrode polarisation is not possible to achieve the required effect e.g. electropolishing (anodic) and electroplating (cathodic) where a constant polarisation is required, hence a direct electrical contact is preferred.

Ultrasound devices have been shown to improve surface removal rates and increase mass transport in chemical and electrochemical applications. U.S. Pat. No. 6,315,885 B (NAT SCIENCE COUNCIL [US]) 13 Nov. 2001 describes a method of electro polishing aided by ultrasonic means having the capability of rapidly discharging dregs. The systems previously described in the field use a DC electro polishing apparatus and requires direct contact with the workpiece which are not features of the current invention.

Electrolytic treatment systems are known that feature a moving workpiece which acts as a bipolar electrode and passes over stationary electrodes. An example of such a system is the electrolytic pickling or descaling of oxides from heat treatment of continuous metal products such as strip or wire. The product being treated moves past electrodes of alternating polarity in an electrolyte bath. The product experiences alternate cathodic and anodic reactions as a bipolar electrode. Between the anode and the cathode regions on the non-directly electrically contacted workpiece, the current passes along the product being treated.

In summary there are no known methods for the treatment of the radioactively contaminated surfaces of fixed installed articles that do not involve a direct electrical connection being made to the workpiece or involve the use of alternating the applied voltage or changing the polarisation of the electrodes in the system, with other methods making electrical contact with the workpiece to form the electrical circuit. This need to make contact with the workpiece is a problem because in an existing structures infrastructure may not allow access to appropriate connection points, which may include long and convoluted and inaccessible pipe-runs or be buried in places where obtaining safe electrical connection points to the workpiece in close proximity to the section to be treated may not be possible. Creating a direct electrical connection to the workpiece in these circumstances creates the risk of causing unintentional and uncontrolled corrosion occurring elsewhere in the structure which could lead to release of radioactivity.

A further consideration is that amongst the surface treatment decontamination methods known in the nuclear industry there are none that achieve the desired combination of rapid surface decontamination and good controllability whilst retaining the ability to use conventional effluent treatment plants built from stainless steel.

For the nuclear industry it is important to have a rapid and effective process, and one that generates an effluent that can be dealt with subsequently using conventional plant, which is to say that it does not corrode that plant, and in particular the use of chloride, fluoride and other organic anions which may compromise abatement performance in the effluent treatment plant by complexing radionuclides is avoided.

Compared to previously described processes the system allows rapid surface treatment, with effective control of the system, and for the electrodes to be moved in relation to the workpiece. It avoids the risk of unintentional corrosion arising from earth leakage currents that may arise when the fixed metal object being treated is in direct electrical contact with the power supply for the electrolytic treatment and it is impossible to characterize sufficiently all the earth leakage paths.

The method combines the high rate of electrochemical removal processes, the effective control of an electrochemical process, and the use of a system that can be easily traversed across a surface without the need to make separate electrical contact with the materials except through the electrolyte. The combination of electrical waveform type, electrolyte choice, design of the electrode, electrode support and travel arrangement and seal structures if used achieves the objectives.

### SUMMARY OF THE INVENTION

According to the present invention an electrolytic treatment system to decontaminate the surface of a radioactively contaminated metallic workpiece comprises at least two electrodes, each in close proximity to the surface but not in direct electrical contact and separated from the surface by an electrolyte by a distance sufficient to allow movement of the electrodes along the surface, the electrodes being connected to an alternating current source, which when the system is in use, flows between the electrodes though the metallic workpiece.

In some embodiments there are more than two electrodes at least one of which is connected to the current source with one polarity and at least one of which is connected to the current source with the opposite polarity.

The system provides a method of removing nuclear contamination from a surface where there is no direct electrical contact between the electrolysis power supply and the workpiece. The workpiece is stationery and acts as a bipolar electrode in an electrical circuit between powered anode and cathode electrodes, with an electrically conductive electrolyte providing a current path. The surface of the workpiece closest to the powered anode becomes a cathode, current passes through the metallic workpiece and exits through the surface of the workpiece closest to the external powered cathode which acts as an anode. Anode and cathode reactions occur on the workpiece surface in an identical manner to directly powered electrodes. The electrode reactions can be used for cleaning, metal dissolution and coating. It should be noted that the workpiece will function as an anode and cathode at different times as the current exits and enters the workpiece and consequently the sequence of anodic and cathodic polarizations needs to be considered in designing the treatment system. This electrolytic treatment system can be used with both DC, biased AC and AC currents and in each case the polarization of the electrode will cause the field experienced in the surface to vary.

In the design of such an electrolytic treatment system, besides the desired electrical path through the non-contacted workpiece which acts as a bipolar electrode, there is another current path directly between the powered electrodes. This direct path does no electrochemical work on the product and represents wasted current. Consequently, in the system design the electrical resistance of this path should be increased relative to the path through the workpiece by use of insulators and larger separation distances and the control of the conductivity of the solution.

The electrode device includes a plurality of pairs of electrodes that are located close to but not touching the article being treated and may move across, or be stationary in relation to, or may move step wise across the surface of the article being treated, including moving along the surface of an object. There is no direct connection between the electrodes and the surface being treated.

In the case of the treatment of the surface of an object multiple electrodes are arranged along some portion of the object. Additionally, each electrode may be circular or may include other geometries or may be a collection of deformable and reconfigurable array of electrodes to match the surface contour. Additionally, it may be divided into a plurality of electrically insulated sectors or arcs to allow localized treatment. In the case of the treatment of workpieces with other geometries, for example the internal or external surfaces of ducts or gloveboxes, then the treatment device features electrodes that are set off from the surface by a spacer.

In this invention the surface of the workpiece closest to the powered anode becomes a cathode, current passes through the metallic workpiece and exits through the surface closest to the external powered cathode at which point the workpiece locally acts as an anode. This allows the material to be sequentially treated as the anode then cathode either as the system moves parallel to the surface being treated or by variation of the applied voltage to reverse the polarity. As such the surface will experience being both an anode and cathode at different times as the current exits and enters the product. Further the advantage of localized treatment is that the current flows in a controlled section of the treated surface removing concerns around stray current paths that could lead to safety concerns or unintended electrochemical effects in the system and yields greater control of both the application rate and location when compared to previously described systems.

The system described may be deployed in a flooded pipe or vessel and it can be used in combination with liquid sealing arrangements such that the electrolyte is contained within a volume restricted to the locality of the electrode head. Seals may be of different sorts including but not limited to sponge seals, gasket seals, inflatable seals, rotating flexible seals, frozen plugs.

The system described may be operated with ultrasonic energy applied with the electric field to enhance the rate of material removal and aid the mass transport phenomena at the surface.

The device is connected to a unit that supplies it with electrical power and may additionally supply electrolyte solutions, ventilation and gas removal, other working fluids, data link, by means of an umbilical.

The electrode assembly may be articulated with the objective of being able to pass around bends in pipes.

In the invention it is possible to move the electrodes in relation to the surface being treated.

In the process described the surface of the metal being treated is dissolved in the electrolyte near the electrodes.

The system includes an electrode support structure that prevents the electrodes from contacting the surface being treated and, optionally, a method for sealing and containing the electrolyte fluid allow contact between the electrolyte and with both the electrodes and the surface being treated.

### BRIEF DESCRIPTION OF THE DRAWINGS

FIG. 1 is a schematic drawing of a system according to the invention for treating the internal surface of a pipe;

FIG. 2 is a graphical illustration of the impact of the invention piece when metal is etched from the workpiece, and

FIG. 3 is a schematic drawing of a system according to the invention for treating a planer surface.

### DETAILED DESCRIPTION OF THE PREFERRED EMBODIMENTS

### 1. Treating the Internal Surface of a Pipe

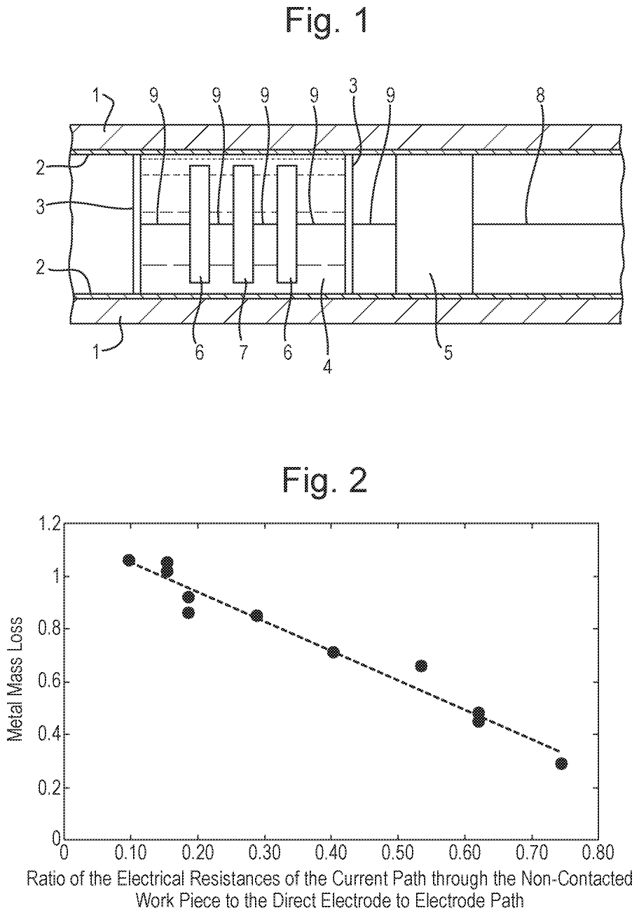

FIG. 1 shows an embodiment of the invention intended for the treatment of the internal surfaces 2, of a pipe 1. The working region of the pipe is flooded with an electrolyte solution 4. There may optionally be provided seals 3 which contain the electrolyte to the immediate vicinity of the electrodes or in the absence of such seals the entire volume of the pipe may be flooded. Insulating materials 7 are present between a pair of electrodes 6. An arrangement 5 is provided to support the electrode assembly and propel it along the pipe. The electrodes 6 are kept at a defined distance from the inside surface of the pipe by means of the support arrangement 5. The electrical current path is from electrodes 6, across the electrolyte-filled gap to the surface of the pipe, along the pipe and then across the electrolyte filled gap to the other electrode 6 and then through the external power circuit and back to the first electrode. The various parts of the electrode treatment device are connected by connecting structures 9. An umbilical connection 8 takes power, data and liquid connections along the pipe to a remote power and control unit outside the pipe.

### Example of Embodiment 1

Sections of 304 stainless steel pipe were EASD treated in nitric acid solutions of two different concentrations at an applied current of 8 A for 30 minutes. The etching power supply produced a 50 Hz waveform of consisting of 13 mS in one polarity and 7 mS with reversed polarity.

The pipe had an internal diameter of 104 mm, was immersed vertically in a bath of nitric acid and had no direct electrical contact with the etching power supply. The internal surface of the pipe was electrochemically treated with a non-contacting pair of electrodes which were directly connected to the opposite polarities of the etching power supply and were mounted in the center of the pipe with a mechanism to allow them to be moved up and down the pipe either continuously or stepwise.

The effect of changes to the geometry of internal energized electrodes and the electrolyte resistivity on the relative electrical resistance of the direct electrode to electrode current path and the path via the workpiece on the mass loss on the internal surface of a section of 304 stainless steel pipe subject to electrochemical treatment are shown below. A current of 8 A was applied for 30 minutes and the etching power supply produced a 50 Hz waveform of consisting of 13 mS in one polarity and 7 mS with reversed polarity.

The directly energized electrodes had diameters (7.1, 8.1 9.1 cm), were 2 cm long and were separated by various distances (1.0, 2.0, 3.2, 3.9 and 6.3 cm) by electrical insulating discs of the same diameter as the electrodes.

The applied voltage causes a current to pass between the directly energized electrodes through the electrically conducting electrolyte via electron exchange reactions at the electrode electrolyte interfaces. The electron exchange reactions do the electrochemical work including metal dissolution. There is a direct current path between the energized electrodes just through the conducting electrolyte which does no electrochemical work on the pipe and an indirect path which does electrochemical work (etching) on the inside of the pipe. The path is energized electrode to electrolyte to internal surface of the pipe opposite the electrode then along the highly conducting pipe wall to the internal surface opposite the other electrode then into the electrolyte and back into opposite polarity electrode.

The electrical resistance of the direct path and the path through the workpiece where metal is etched from the workpiece were calculated and the metal loss plotted as a function of their ratio in FIG. 2. This incorporates both distance and electrolyte changes.

Metal loss from the workpiece decreases as the ratio of the workpiece path to the short circuit path directly from electrode to electrode increases. This is logical as more current will flow down the lower resistance path. Thus, the metal removal rate or process efficiency can be controlled by adjusting the geometry and electrolyte conductivity.

The results show that:

The pipe which had no direct electrical contact to the power supply lost mass when electrochemically treated demonstrating that non-contact electrochemical etching can be effectively carried out on a pipe.

The relative metal removal efficiency as determined by sample mass loss of the tube was substantially the same whether the electrodes are stationary or scanned down the sample pipe.

The relative metal removal efficiency as determined by sample loss of the tube demonstrates that the proportion of the current used in the non-contact etching process is increased if the electrical resistance of the direct path between the directly energized electrodes is increased by decreasing the electrolytic conductivity.

When the ratio of the electrical resistance of the current path through the non-contact workpiece to the direct electrode to electrode path is greater than 0.6 there is already a significant improvement in metal removal efficiency; this is even more marked reduction in metal loss; but as the ratio falls further to 0.3 there is an even greater improvement.

### Embodiment 2. Treating a Planar Surface

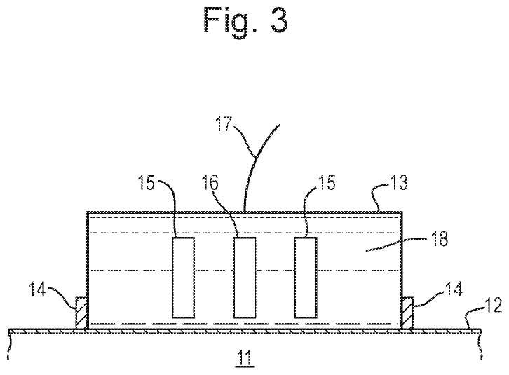

FIG. 3 shows a surface layer 12 that is to be removed. The working area is surrounded by an enclosure 13 which is filled with an electrolyte solution 18. Optionally a sealing arrangement 14 prevents leakage of the electrolyte from within the sealed area. Insulating pieces 16 separate one electrode 15 from another electrode 15 opposite polarity. Electrodes 15 are held at a defined distance from the surface 2. The insulating pieces 16 separate the electrodes 15 and minimize current flowing through the electrolyte directly between the electrodes 15. An umbilical 17 carries power, data and electrolyte supplies to the device. An external means of moving the whole assembly across the surface to be treated is provided.

Nitric acid is the preferred base electrolyte. This is compatible with standard radionuclide recovery plants and does not corrode the materials of construction. The dissolved metal in nitric acid can be subsequently precipitated or crystallized by evaporation of the water, providing an abatement route for the spent electrolyte and metals/radionuclides.

In each of FIGS. 1 and 3 only one pair of electrodes is shown, in practice, the carrier 9 or cover 13 could contain a number of pairs of electrodes all electrically isolated from one with insulating material 7 or pieces 16.

General for all Embodiments

The electrical waveform for use in the decontamination process is preferably a DC-biased AC waveform. It is also desirable to have the possibility to reverse the polarity of the DC bias periodically. This has the effect of changing the balance between amounts of hydroxyl ion and hydrogen produced, which is beneficial for preventing passivation and helps scrub the surface. The DC bias may optionally be varied in a continuous manner.

The current density is an important aspect of the invention as it affects the concentration of hydroxyl ions. Hydroxyl ions are important as they help to combat passivation and hydrogen generation. Greater current densities are beneficial therefore, but only up to a point, since at higher current there is a loss of efficiency due to resistive heating that is proportional to the square of the current. In practice there is an optimum current density. The preferred current density is between 0.1 and 1 amp per square centimeter, and more preferably between 0.4 and 0.2 amps per square centimeter.

The frequency of the AC component of the waveform used may be in the range 1-1000 Hz. The preferred frequency is in the range 5-100 Hz. As frequency increases less of the electrical energy is used in the desired electrochemical conversion, because of the capacitance of the interface, but the alternating current aids removal of passivation via scrubbing and other mechanisms, and in practice a frequency of between 5-100 Hz is preferred. The preferred frequency is dependent to some extent on the electrolytes used.

The electrodes can be of variable spacing and geometry to suit the application. Insulators may be included between and around the electrodes or may be included around electrodes to prevent or reduce the electrical short circuiting but allow fluid to pass via either/or both internal external path with internal compartments.

The AC frequency is between 1 Hz and 1000 Hz inclusive, but normally the range is between 2 Hz and 500 Hz inclusive, but usually with best results being obtained between 5 Hz and 100 Hz inclusive.

The electrolyte used may also contains one or more of a chloride salt, a fluoride salt, and an organic acid or a complexing agent.

The eluent stream resulting from the surface treatment can be subsequently be electrochemically treated remove chloride and organic molecules.

During the treatment, ultrasonic energy can be applied to the system to improve the efficiency and effectiveness of the electrochemical process.

To help monitor the system in use, the spaces between the electrodes contains instrumentation such as, but not limited to, radiation sensor, ultrasound x-ray or other non-destructive evaluation techniques, pH sensor conductivity sensor, Raman or infrared probe. In addition, or as an alternative, instrumentation is mounted ahead or behind the electrodes and used to control one or all the following; movement rate, position, location, processing time, current density, voltage control, fluid flow rate or other control actions.

What is claimed is:

1. An electrolytic treatment system to decontaminate the surface of a radioactively contaminated metallic workpiece comprising:
at least two electrodes, each in close proximity to the surface but not in direct electrical contact and separated from the surface by an electrolyte by a distance sufficient to allow movement of the electrodes along the surface; and
insulation in the electrolyte between the electrodes, said insulation minimizing any direct current path between the electrodes otherwise than through the workpiece.

2. The electrolytic treatment system according to claim wherein the electrodes are alternatingly polarized as cathodes and anodes using a DC supply.

3. The electrolytic treatment system according to claim wherein the electrodes are alternatingly polarized as cathodes and anodes when an AC voltage is applied.

4. The electrolytic treatment system according to claim where the electrodes are alternatingly polarized as cathodes and anodes when a DC biased AC voltage is applied.

5. The electrolytic treatment system according to claim 1, further including seals that contain the electrolyte solution to a region of the article surface being treated, and wherein the electrodes may be configured with variable spacing and geometry and conveyed across the article surface.

6-7. (canceled)

8. The electrolytic treatment system according to claim 3, wherein the alternating current frequency is between 1 Hz and 1000 Hz inclusive.

9. The electrolytic treatment system according to claim 8, wherein the alternating current frequency is between 2 Hz and 500 Hz inclusive.

10. The electrolytic treatment system according to claim 9, wherein the alternating current frequency is between 5 Hz and 100 Hz inclusive.

11. (canceled)

12. The electrolytic treatment according to claim 10, wherein the electrolyte contains less than 10% v/v nitric acid.

13. The electrolytic treatment according to claim 1, wherein the electrolyte contains 2% v/v nitric acid.

14. The electrolytic treatment system according to claim 1, wherein the electrolyte contains one or more of a chloride salt and an organic complex.

15. The electrolytic treatment system according claim 1, wherein the electrolyte is totally or partially retained in a porous structure with connected pores.

16. The electrolytic treatment system according to claim 14, further comprising a pump to recirculate the electrolyte fluid to the electrodes and a treatment station in which the eluent stream is treated electrochemically to remove chloride and organic complexes.

17. The electrolytic treatment system according to claim 1, further comprising an ultrasonic energy source to improve the efficiency and effectiveness of the electrochemical process.

18. The electrolytic treatment system according claim 5, wherein the electrode assembly includes one or more sensors comprising radiation sensors, ultrasound x-ray or other non-destructive sensors, pH sensors, conductivity sensors, Raman or infrared probes.

19. The electrolytic treatment system according to claim 18, wherein the one or more sensors are mounted ahead or behind the electrodes wherein the sensor data is used to control at least one of movement rate, processing time, current density, voltage control, fluid flow rate or other control actions.

20. The electrolytic treatment system according to claim 1, further comprising a power supply in an isolated circuit wherein the voltage applied to the electrodes has no reference to ground potential.

21. (canceled)

22. The electrolytic treatment system as in claim 20, wherein the voltage bias on the electrodes are alternatingly reversed.

23. The electrolytic treatment system according to claim 22, in which the ratio of the resistance of the current path through the non-contacted workpiece to the direct electrode to electrode path is 0.6 or less.

24. The electrolytic treatment system according to claim 1, in which the ratio of the resistance of the current path through the non-contacted workpiece to the direct electrode to electrode path is 0.3 or less.
